(19) United States
(12) Patent Application Publication
(10) Pub. No.: US 2024/0242599 A1
(43) Pub. Date: Jul. 18, 2024

(54) INTELLIGENT COLLABORATION BETWEEN AUTONOMOUS AND NON-AUTONOMOUS VEHICLES

(71) Applicant: International Business Machines Corporation, Armonk, NY (US)

(72) Inventors: Sarbajit K. Rakshit, Kolkata (IN); Satyam Jakkula, Bengaluru (IN); Sudhanshu Sekher Sar, Bangalore (IN); Sudheesh S. Kairali, Kozhikode (IN)

(21) Appl. No.: 18/154,074

(22) Filed: Jan. 13, 2023

(51) Int. Cl. G08G 1/01; B60K 35/00; B64C 39/02; B64U 20/87; G05D 1/10

(52) U.S. Cl. CPC G08G 1/0141; B60K 35/00; B64C 39/024; B64U 20/87; G05D 1/104; B64U 2101/20

(57) ABSTRACT

A computer-implemented method, system and program product enabling communication and collaboration between autonomous vehicles and non-autonomous driving along a shared roadway. Autonomous vehicles having difficulty traveling along the roadway or making driving decisions due to the presence of non-autonomous vehicles request deployment of unmanned aerial vehicles (UAV). Based on the current driving conditions, the number of non-autonomous vehicles and other factors, a number of UAVs are deployed and attached to the non-autonomous vehicles. The UAVs scan the surrounding environment and nearby vehicles within the environment. UAVs transmit scanned images, sensor data and other information to the nearby autonomous vehicles which generate driving decisions based on the data collection of the autonomous vehicle in conjunction with data provided by UAVs. Driving decisions of autonomous vehicles are transmitted to the UAVs. UAVs project the driving decisions of autonomous vehicles onto windshields, HUDs or display systems of the attached non-autonomous vehicle.

### BACKGROUND

The present disclosure relates generally to the field of artificial intelligence (AI), autonomous and non-autonomous vehicles, and more specifically integration of communication, coordination and collaboration between autonomous and non-autonomous vehicles operating alongside each other despite differences in the set of capabilities available to the different types of vehicles.

An autonomous vehicle (otherwise known as a driverless vehicle), is a vehicle that is able to operate itself or perform driving functions without human intervention using the vehicle's ability to sense the surrounding environment. Autonomous vehicles can utilize a fully automated driving system in order to respond to external conditions outside of the vehicle that a human would normally manage and navigate while piloting a vehicle. The level of autonomy am autonomous vehicles may be described by one of six levels. At level 0, the vehicle does not control its operations and humans' control all of the driving operations (i.e., non-autonomous). At level 1, a vehicle's advanced driver assistance system (ADAS) can support the human driver by assisting with steering, accelerating and/or braking. At level 2, a vehicle's ADAS can oversee steering, accelerating and braking in certain condition, but a human driver is required to pay complete attention to the vehicle and driving environment throughout operation of the vehicle. At level 3 an advanced driving system (ADS) may be operational within the vehicle, performing all driving tasks in some conditions, however a human driver can be required to regain control over the vehicle when requested by the vehicle's ADS. At level 4 the vehicle's ADS performs all driving tasks independently in certain conditions while human attention is not required. Lastly, at level 5 the vehicle is fully automated whereby the vehicle's ADS is able to perform all tasks in all conditions without any driving assistance from a human operator.

Unmanned aerial vehicles (UAV) may refer to aircraft such as airplanes, helicopters, drones and other devices that are capable of obtaining flight, maintaining flight patterns and landing without the requirement of a human pilot onboard the aerial vehicle. UAVs can be autonomous, semi-autonomous or non-autonomous. Autonomous and semi-autonomous UAVs can operate using AI powered navigation and operational systems that can complete tasks and/or make decisions on their own (fully autonomous) or in conjunction with input from a human operator on the ground (semi-autonomous). A non-autonomous UAV may operate based on remote input from human operators inputting instructions. For example, by using a remote control or wireless communication device. A UAV can include fully autonomous drones that do not require a human operator at all and/or drones that can be manually piloted by human operators from a distance.

### SUMMARY

Embodiments of the present disclosure relate to computer-implemented methods, associated computer systems and computer program products for maximizing collaboration between autonomous and non-autonomous vehicles. The computer-implemented method comprises deploying an unmanned aerial vehicle (UAV) to an environment comprising the autonomous vehicles and the non-autonomous vehicles driving on a roadway; attaching the UAV to one or more of the non-autonomous vehicles; pairing the UAV with one or more of the autonomous vehicles within the environment; scanning, by the UAV, the environment and vehicles surrounding the UAV attached to one or more non-autonomous vehicles; transmitting, by the UAV, images or sensor data collected by scanning the environment and the vehicles surrounding the UAV attached to the one or more non-autonomous vehicles; receiving, by the UAV, a driving decision from one or more of the autonomous vehicles; and projecting, by the UAV, the driving decision of the one or more autonomous vehicles onto a windshield or display device of the one or more non-autonomous vehicles attached to the UAV.

### BRIEF DESCRIPTION OF THE DRAWINGS

The drawings included in the present disclosure are incorporated into, and form part of, the specification. The drawings illustrate embodiments of the present disclosure and, along with the description, explain the principles of the disclosure. The drawings are only illustrative of certain embodiments and do not limit the disclosure.

FIG. 1 depicts a block diagram illustrating an embodiment of a computer system and the components thereof, upon which embodiments described herein may be implemented in accordance with the present disclosure.

FIG. 2 depicts a block diagram illustrating an extension of the computing system environment of FIG. 1, wherein the computer systems are configured to operate in a network environment (including a cloud environment), and perform methods described herein in accordance with the present disclosure.

FIG. 3 depicts a functional block diagram describing an embodiment of a system for maximizing collaboration between autonomous and non-autonomous vehicles, in accordance with the present disclosure.

FIG. 4A illustrates an example of a driving environment comprising a mixture of autonomous and non-autonomous vehicles operating beside each other without an ability to communicate and/or coordinate driving decisions between the autonomous and non-autonomous vehicles.

FIG. 4B illustrates the driving environment of FIG. 4A comprising a plurality of UAVs attaching to one or more non-autonomous vehicles, facilitating communication and coordination of driving decisions of the autonomous to the non-autonomous vehicles, maximizing collaboration between all vehicles within the driving environment, in accordance with the present disclosure.

FIG. 5A depicts a functional block diagram illustrating an embodiment of one or more components of transportation service placed in communication with one or more autonomous vehicle and/or UAVs maximizing collaboration between autonomous and non-autonomous vehicles, in accordance with the present disclosure.

FIG. 5B depicts a functional block diagram illustrating an embodiment of one or more components of a scanning and projection module equipped by a UAV maximizing collaboration between autonomous and non-autonomous vehicles, in accordance with the present disclosure.

FIG. 6A illustrates a flow diagram describing an embodiment of a method for maximizing collaboration between autonomous and non-autonomous vehicles, in accordance with the present disclosure.

FIG. 6B illustrates a continuation of the flow diagram of FIG. 6A describing the embodiment of the method for maximizing collaboration between autonomous and non-autonomous vehicles, in accordance with the present disclosure.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The corresponding structures, materials, acts, and equivalents of all means or steps plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments chosen and described are in order to best explain the principles of the disclosure, the practical applications and to enable others of ordinary skill in the art to understand the disclosure for various embodiments with various modifications as are suited to the particular use contemplated.

### Overview

As modern roadways make a shift from non-autonomous vehicles to autonomous vehicles, there will be a period of time before the transition to a roadway comprising entirely autonomous vehicles. During this transition period, a combination of both non-autonomous and autonomous vehicles must co-exist while traveling along the road and highways. Autonomous vehicles may have certain data capturing and processing capabilities that are unavailable to the non-autonomous vehicles on the roadway. For example, autonomous vehicles may comprise scanning equipment such as infrared cameras, thermal cameras, Light Detection and Ranging (LiDAR) and a plurality of different types of sensors. Manually driven, non-autonomous vehicles on the other hand, may have varying degrees of different capabilities. For example, some non-autonomous vehicles may comprise sensors that detect nearby objects or obstacles and issue alerts to the driver when the vehicle comes to close to the object or obstacle (such as another vehicle). Other types of non-autonomous vehicles may not include any sensors that detect nearby objects or obstacles at all and may not be capable of issuing an alert to the driver. Due to a wide range of different capabilities between autonomous and non-autonomous vehicles, when autonomous vehicles are traveling along the roadway, the autonomous vehicle may have difficulty moving properly and/or keeping a safe distance from non-autonomous vehicles that do not detect nearby surroundings or alert the driver of nearby hazards. A solution is therefore required that bridges the gap between the capabilities of the different types of vehicles traveling along the roadway by improving detection of vehicle surroundings on behalf of non-autonomous vehicles lacking such capabilities natively as well as improving communication and collaboration between vehicles sharing the roadway, despite vastly different features or automation capabilities.

Embodiments of the present disclosure provides a method, system and computer program products that may dynamically decide, based on the current environmental conditions, roadway conditions and the composition of the traffic on the roadway, which non-autonomous vehicles traveling along the roadway should be assisted with additional capabilities that are not native to the vehicle. Embodiments of the present disclosure can identify which kinds of features can be attached to the vehicle(s) based on context of collaboration among the vehicles that are co-located among one another on the roadway (both autonomous and non-autonomous) in order to maximize collaboration effectiveness. Embodiments of the present disclosure can introduce the additional capabilities to the non-autonomous vehicles by employing the assistance of a UAV. UAVs being deployed to a roadway environment can hover above one or more non-autonomous vehicles or attach to the non-autonomous vehicles. Additional data gathering, performance and communicative capabilities implemented by the UAV provide assistance to the autonomous vehicles on the roadway and may be flexible or change depending on the performance level of the surrounding vehicles.

Autonomous vehicles positioned along a roadway that are having difficulty traveling along said roadway or may be having trouble making driving decisions due to the presence of non-autonomous vehicles can request deployment one or more UAVs. Based on the current driving conditions, the number of non-autonomous vehicles and other factors, a number of UAVs can be dispatched to an area surrounding the requesting autonomous vehicle. One or more UAVs may hover or attach themselves to nearby non-autonomous vehicles. Once deployed to the area surrounding the requesting autonomous vehicle, each deployed UAVs may use onboard scanning systems, imaging devices or sensor systems to scan the surrounding environment and nearby vehicles within the environment. For example, using thermal imaging, infrared imaging, LiDAR, and other onboard systems of the UAV to collect data of the surrounding environment, in a manner that may be similar to the nearby autonomous vehicles operating on the roadway. Embodiments of the UAVs may transmit the collected data of the surrounding environment, including scanned images, sensor readings, and other information to the nearby autonomous vehicles. Upon receipt of the collected data generated by one or more of the UAVs, autonomous vehicles driving along the roadway may combine the UAV-generated data with environmental data collected by the autonomous vehicle in order to predict and generate optimal driving decisions and actions to be implemented by the autonomous vehicle.

The UAVs scanning the surrounding area and autonomous vehicles making driving decisions based on the collected UAV data in addition to the autonomous vehicle's own gathered data, may be collaborating and performing computations as an edge computation.

Once generated, the driving decisions created by one or more of the nearby autonomous vehicles can transmitted to the paired UAVs. Embodiments of the UAVs may communicate the driving decisions intending to be implemented by the nearby autonomous vehicles to the non-autonomous vehicles, for example by laser projecting the driving decisions of autonomous vehicles onto windshields, or by transferring the driving decisions to a heads-up display (HUD) within the non-autonomous vehicle, or other type of display system, alert system and/or augmented reality device that is capable of being placed in communication with the UAV attached to the non-autonomous vehicle. As drivers of the non-autonomous vehicles are informed of the driving decisions being implemented by nearby autonomous vehicles, drivers may collaborate and coordinate driving actions of the non-autonomous vehicles in anticipation of the driving decisions being made by the nearby autonomous vehicles. Improving coordination amongst all nearby vehicles on the roadway, despite the lack of built in capabilities of the non-autonomous vehicle. Once driving conditions and/or roadway conditions improve and collaboration between the autonomous and non-autonomous vehicles is no longer required or requested, the UAVs may detach from the non-autonomous vehicles and remove themselves from the surrounding environment until the UAVs are requested or reassigned to another driving environment.

The collaboration between the UAVs scanning the surrounding area, the autonomous vehicles making driving decisions based on the collected UAV data in addition to the autonomous vehicle's own gathered data, and the UAVs guiding the non-autonomous vehicles using projections of driving decisions, may be performed as edge computations. Edge computing is a method of processing data and running applications as close to the source of the data as possible, rather than sending all the data to a centralized data center or cloud for processing. Edge computing allows data to be processed at the edge of the network, closer to the devices that generate it, reducing the amount of data that needs to be sent to a centralized location for processing. In other words, the computations and collaboration between the UAV and autonomous vehicles may be happening at the UAV and autonomous vehicle location, rather than relying on a centralized server or the cloud to process the data and return the information to the UAV. This can improve the efficiency, performance, and responsiveness of UAV and autonomous vehicles because they may rely on real-time data.

### Computing System

Various aspects of the present disclosure are described by narrative text, flowcharts, block diagrams of computer systems and/or block diagrams of the machine logic included in computer program product (CPP) embodiments. With respect to any flowcharts, the operations can be performed in a different order than what is shown in the flowchart. For example, two operations shown in successive flowchart blocks may be performed in reverse order, as a single integrated step, concurrently, or in a manner at least partially overlapping in time. A computer program product embodiment (“CPP embodiment”) is a term used in the present disclosure that may describe any set of one or more storage media (or “mediums”) collectively included in a set of one or more storage devices. The storage media may collectively include machine readable code corresponding to instructions and/or data for performing computer operations. A “storage device” may refer to any tangible hardware or device that can retain and store instructions for use by a computer processor. Without limitation, the computer readable storage medium may include an electronic storage medium, a magnetic storage medium, an optical storage medium, an electromagnetic storage medium, a semiconductor storage medium, a mechanical storage medium, and/or any combination thereof. Some known types of storage devices that include mediums referenced herein may include a diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination thereof.

A computer-readable storage medium should not be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As understood by those skilled in the art, data is typically moved at some occasional points in time during normal operations of a storage device, such as during access, de-fragmentation or garbage collection. However, such movement of the data during operations does not render the storage device as transitory because the data is not transitory while it is stored.

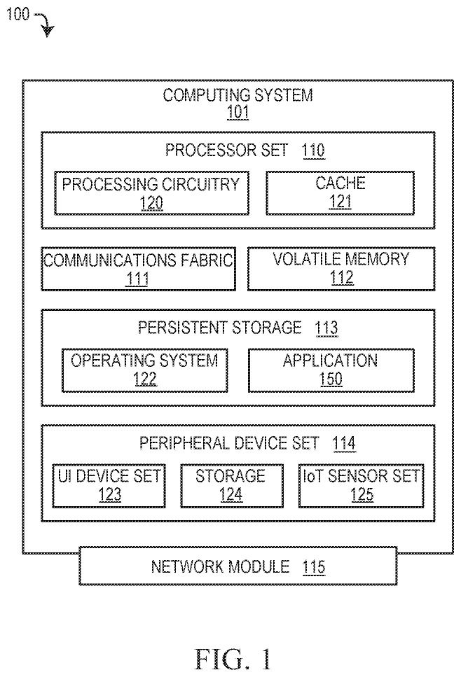

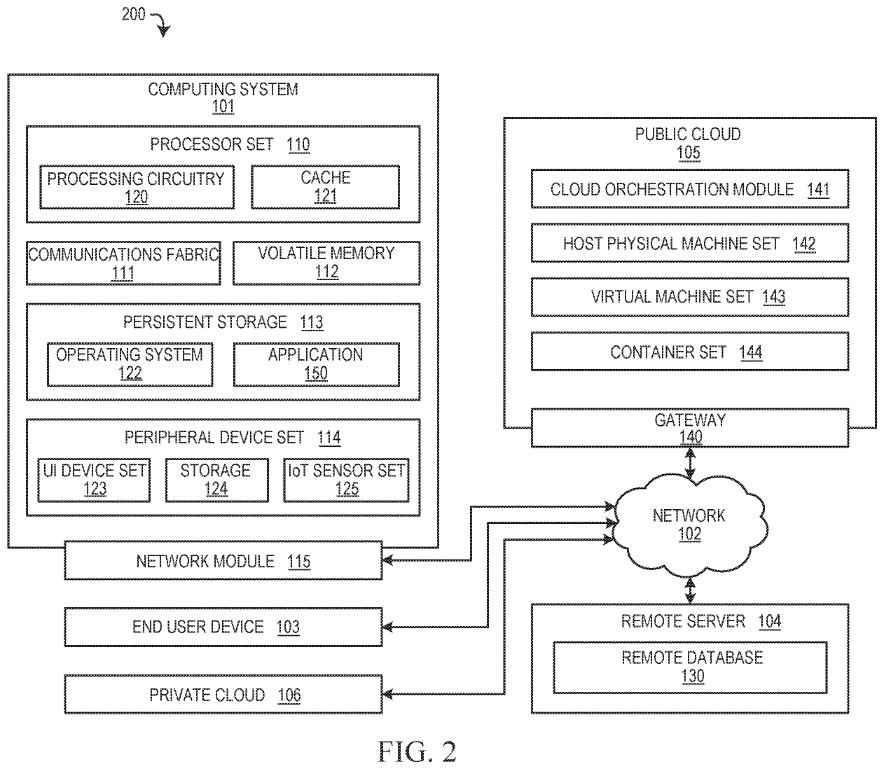

FIG. 1 illustrates a block diagram describing an embodiment of a computing system 101 operating within a computing environment 100. The computing system 101 may be a simplified example of a computing device (i.e., a physical bare metal system and/or a virtual system) capable of performing the computing operations described herein. Computing system 101 may be representative of the one or more computing systems or devices implemented in accordance with the embodiments of the present disclosure and further described below in detail. Computing system 101 as depicted in FIG. 1 (and FIG. 2) provides only an illustration of one implementation of a computing system 101 and does not imply any limitations regarding the environments in which different embodiments may be implemented. In general, the components illustrated in the computing system 101 may be representative of an electronic device, either physical or virtualized, that is capable of executing machine-readable program instructions.

Embodiments of computing system 101 may take the form of a desktop computer, laptop computer, tablet computer, smart phone or other type of mobile communications device, smart watch or other wearable computer such as a virtual reality headset, augmented reality headset, glasses or wearable accessory. Embodiments of the computing system 101 may also take the form of a mainframe computer, server, quantum computer, a non-conventional computer system such as an autonomous vehicle (including automobiles, as well as UAVs in the form of helicopters, airplanes, drones, etc.) or home appliance, or any other form of computer or mobile device now known or to be developed in the future that is capable of running an application 150, accessing a network 102 or querying a database, such as remote database 130. Performance of a computer-implemented method executed by a computing system 101 may be distributed among multiple computers and/or between multiple locations. Computing system 101 may be located as part of a cloud network, even though it is not shown within a cloud in FIGS. 1-2. Moreover, computing system 101 is not required to be part of a cloud network except to any extent as may be affirmatively indicated.

Processor set 110 can include one or more computer processors of any type now known or to be developed in the future. Processing circuitry 120 may be distributed over multiple packages. For example, multiple, coordinated integrated circuit chips. Processing circuitry 120 may implement multiple processor threads and/or multiple processor cores. Cache 121 may refer to memory that is located on the processor chip package(s) and/or may be used for data or code that can be made available for rapid access by the threads or cores running on processor set 110. Cache 121 memories can be organized into multiple levels depending upon relative proximity to the processing circuitry 120. Alternatively, some, or all of cache 121 of processor set 110 may be located “off chip.” In some computing environments, processor set 110 may be designed for working with qubits and performing quantum computing.

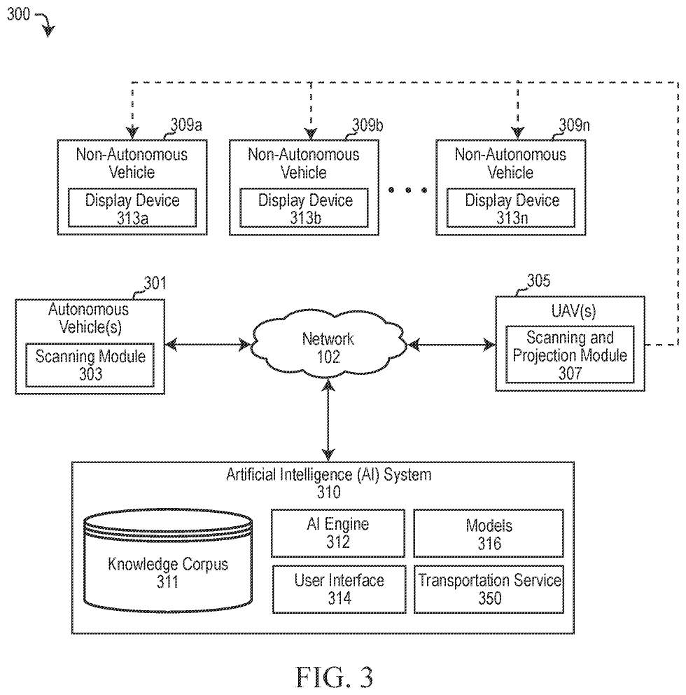

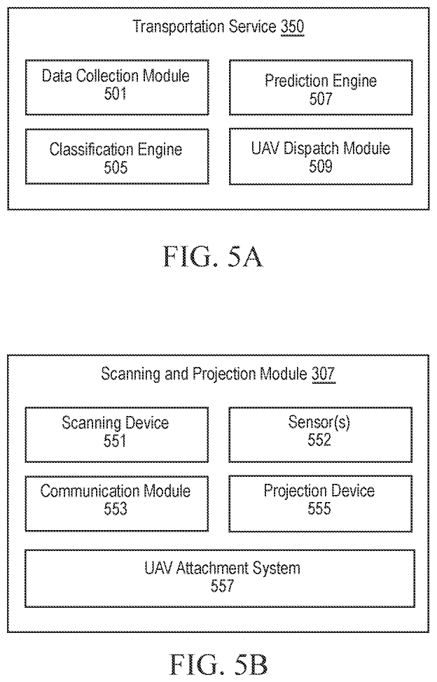

Computer readable program instructions can be loaded onto computing system 101 to cause a series of operational steps to be performed by processor set 110 of computing system 101 and thereby implement a computer-implemented method. Execution of the instructions can instantiate the methods specified in flowcharts and/or narrative descriptions of computer-implemented methods included in this specification (collectively referred to as “the inventive methods”). The computer readable program instructions can be stored in various types of computer readable storage media, such as cache 121 and the other storage media discussed herein. The program instructions, and associated data, can be accessed by processor set 110 to control and direct performance of the inventive methods. In computing environments of FIGS. 1-2, at least some of the instructions for performing the inventive methods may be stored in persistent storage 113, volatile memory 112, and/or cache 121, as application(s) 150 comprising one or more running processes, services, programs and installed components thereof. For example, program instructions, processes, services and installed components thereof may include transportation service 350, scanning module 303 and/or scanning and projection module 307 (as shown in FIG. 3). Components of transportation service 350 can include data collection module 501, classification engine 505, prediction engine 507 and/or UAV dispatch module 509, as shown in FIG. 5A. Components of scanning and projection module 307 may include scanning device 551, sensor(s) 552, communication module 553, projection device 555 and/or UAV attachment system 557, as shown in FIG. 5B.

Communication fabric 111 may refer to signal conduction paths that may allow the various components of computing system 101 to communicate with each other. For example, communications fabric 111 can provide for electronic communication among the processor set 110, volatile memory 112, persistent storage 113, peripheral device set 114 and/or network module 115. Communication fabric 111 can be made of switches and electrically conductive paths that make up busses, bridges, physical input/output ports and the like. Other types of signal communication paths may be used, such as fiber optic communication paths and/or wireless communication paths.

Volatile memory 112 may refer to any type of volatile memory now known or to be developed in the future, and may be characterized by random access, but this is not required unless affirmatively indicated. Examples include dynamic type random access memory (RAM) or static type RAM. In computing system 101, the volatile memory 112 is located in a single package and can be internal to computing system 101, but, alternatively or additionally, the volatile memory 112 may be distributed over multiple packages and/or located externally with respect to computing system 101. Application 150, along with any program(s), processes, services, and installed components thereof, described herein, may be stored in volatile memory 112 and/or persistent storage 113 for execution and/or access by one or more of the respective processor sets 110 of the computing system 101.

Persistent storage 113 can be any form of non-volatile storage for computers that may be currently known or developed in the future. The non-volatility of this storage means that the stored data may be maintained regardless of whether power is being supplied to computing system 101 and/or directly to persistent storage 113. Persistent storage 113 may be a read only memory (ROM), however, at least a portion of the persistent storage 113 may allow writing of data, deletion of data and/or re-writing of data. Some forms of persistent storage 113 may include magnetic disks, solid-state storage devices, hard drives, flash-based memory, erasable read-only memories (EPROM) and semi-conductor storage devices. Operating system 122 may take several forms, such as various known proprietary operating systems or open-source Portable Operating System Interface type operating systems that employ a kernel.

Peripheral device set 114 includes one or more peripheral devices connected to computing system 101. For example, via an input/output (I/O interface). Data communication connections between the peripheral devices and the other components of computing system 101 may be implemented using various methods. For example, through connections using Bluetooth, Near-Field Communication (NFC), wired connections or cables (such as universal serial bus (USB) type cables), insertion type connections (for example, secure digital (SD) card), connections made though local area communication networks and/or wide area networks such as the internet. In various embodiments, UI device set 123 may include components such as a display screen, speaker, microphone, wearable devices (such as glasses, googles, headsets, smart watches, clip-on, stick-on or other attachable devices), keyboard, mouse, joystick, printer, touchpad, game controllers, and haptic feedback devices. Storage 124 can include external storage, such as an external hard drive, or insertable storage, such as an SD card. Storage 124 may be persistent and/or volatile. In some embodiments, storage 124 may take the form of a quantum computing storage device for storing data in the form of qubits. In some embodiments, networks of computing systems 101 may utilize clustered computing and/or utilize storage components as a single pool of seamless resources when accessed through a network by one or more computing systems 101. For example, a storage area network (SAN) that is shared by multiple, geographically distributed computer systems 101 or network-attached storage (NAS) applications. IoT sensor set 125 can be made up of sensors that can be used in Internet-of-Things applications. For example, a sensor may be a temperature sensor, motion sensor, light sensor, infrared sensor or any other type of known sensor type.

Network module 115 may include a collection of computer software, hardware, and/or firmware that allows computing system 101 to communicate with other computer systems through a computer network 102, such as a LAN or WAN. Network module 115 may include hardware, such as modems or Wi-Fi signal transceivers, software for packetizing and/or de-packetizing data for communication network transmission, and/or web browser software for communicating data over the network. In some embodiments, network control functions and network forwarding functions of network module 115 are performed on the same physical hardware device. In other embodiments (for example, embodiments that utilize software-defined networking (SDN)), the control functions and the forwarding functions of network module 115 can be performed on physically separate devices, such that the control functions manage several different network hardware devices or computing systems 101. Computer readable program instructions for performing the inventive methods can be downloaded to computing system 101 from an external computer or external storage device through a network adapter card or network interface which may be included as part of network module 115.

FIG. 2 depicts a computing environment 200 which may be an extension of the computing environment 100 of FIG. 1, operating as part of a network 102. In addition to computing system 101, computing environment 200 can include a computing network 102 such as a wide area network (WAN) (or another type of computer network) connecting computing system 101 to one or more end user device (EUD) 103, remote server 104, public cloud 105, and/or private cloud 106. In this embodiment, computing system 101 includes processor set 110 (including processing circuitry 120 and cache 121), communication fabric 111, volatile memory 112, persistent storage 113 (including operating system 122 and application(s) 150, as identified above), peripheral device set 114 (including user interface (UI) device set 123, storage 124, Internet of Things (IoT) sensor set 125), and network module 115. Remote server 104 includes remote database 130. Public cloud 105 can include gateway 140, cloud orchestration module 141, host physical machine set 142, virtual machine set 143, and/or container set 144.

Network 102 may be comprised of wired or wireless connections. For example, connections may be comprised of computer hardware such as copper transmission cables, optical transmission fibers, wireless transmission, routers, firewalls, switches, gateway computers and/or edge servers. Network 102 may be described as any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. Other types of networks that can be used to interconnect the various computer systems 101, end user devices 103, remote servers 104, private cloud 106 and/or public cloud 105 may include Wireless Local Area Networks (WLANs), home area network (HAN), backbone networks (BBN), peer to peer networks (P2P), campus networks, enterprise networks, the Internet, single tenant or multi-tenant cloud computing networks, the Public Switched Telephone Network (PSTN), and any other network or network topology known by a person skilled in the art to interconnect computing systems 101.

End user device 103 can include any computer device that can be used and/or controlled by an end user (for example, a customer of an enterprise that operates computing system 101) and may take any of the forms discussed above in connection with computing system 101. EUD 103 may receive helpful and useful data from the operations of computing system 101. For example, in a hypothetical case where computing system 101 is designed to provide a recommendation to an end user, this recommendation may be communicated from network module 115 of computing system 101 through network 102 to EUD 103. In this example, EUD 103 can display, or otherwise present, the recommendation to an end user. In some embodiments, EUD 103 may be a client device, such as thin client, thick client, mobile computing device such as a smart phone, mainframe computer, desktop computer and so on.

Remote server 104 may be any computing system that serves at least some data and/or functionality to computing system 101. Remote server 104 may be controlled and used by the same entity that operates computing system 101. Remote server 104 represents the machine(s) that collect and store helpful and useful data for use by other computers, such as computing system 101. For example, in a hypothetical case where computing system 101 is designed and programmed to provide a recommendation based on historical data, the historical data may be provided to computing system 101 from remote database 130 of remote server 104.

Public cloud 105 may be any computing systems available for use by multiple entities that provide on-demand availability of computer system resources and/or other computer capabilities including data storage (cloud storage) and computing power, without direct active management by the user. The direct and active management of the computing resources of public cloud 105 can be performed by the computer hardware and/or software of cloud orchestration module 141. The computing resources provided by public cloud 105 can be implemented by virtual computing environments that run on various computers making up the computers of host physical machine set 142, and/or the universe of physical computers in and/or available to public cloud 105. The virtual computing environments (VCEs) may take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through network 102.

VCEs can be stored as “images.” A new active instance of the VCE can be instantiated from the image. Two types of VCEs may include virtual machines and containers. A container is a VCE that uses operating-system-level virtualization, in which the kernel allows the existence of multiple isolated user-space instances, called containers. These isolated user-space instances may behave as physical computers from the point of view of applications 150 running in them. An application 150 running on an operating system 122 can utilize all resources of that computer, such as connected devices, files and folders, network shares, CPU power, and quantifiable hardware capabilities. Applications 150 running inside a container of container set 144 may only use the contents of the container and devices assigned to the container, a feature which may be referred to as containerization.

Private cloud 106 may be similar to public cloud 105, except that the computing resources may only be available for use by a single enterprise. While private cloud 106 is depicted as being in communication with network 102 (such as the Internet), in other embodiments a private cloud 106 may be disconnected from the interne entirely and only accessible through a local/private network. A hybrid cloud may refer to a composition of multiple clouds of different types (for example, private, community or public cloud types), and the plurality of clouds may be implemented or operated by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 may be both part of a larger hybrid cloud environment.

### System for Enabling Communication and Collaboration Between Autonomous and Non-Autonomous Vehicles

It will be readily understood that the instant components, as generally described and illustrated in the Figures herein, may be arranged and designed in a wide variety of different configurations. Accordingly, the following detailed description of the embodiments of at least one of a method, apparatus, non-transitory computer readable medium and system, as represented in the attached Figures, is not intended to limit the scope of the application as claimed but is merely representative of selected embodiments.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Accordingly, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the Figures, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

Referring to the drawings, FIG. 3 depicts an embodiment of a computing environment 300 illustrating a system capable of enabling communication and collaboration between autonomous vehicle(s) 301 and one or more non-autonomous vehicle 309a-309n (referred to herein generally as non-autonomous vehicles 309) operating alongside one another within a driving environment such as a roadway or highway. Facilitation of communication and collaboration between the autonomous vehicle(s) 301 and the non-autonomous vehicles 309 may be performed using one or more UAV(s) 305 to augment non-autonomous vehicles 309 with additional capabilities that may not be onboard or integrated into the non-autonomous vehicle 309. The addition of these capabilities provided by the UAV enable autonomous vehicles 301 to understand the surrounding environment of the non-autonomous vehicle 309 in order to make more accurate driving decisions, while providing the non-autonomous vehicles 309 with those driving decisions being outputted from the autonomous vehicles 301. Said driving decisions of the autonomous vehicles 301 being presented to the non-autonomous vehicles 309 via one or more UAV(s) 305 may be derived from a combination of data collected by the autonomous vehicle 301 directly using onboard scanning devices 551 such as imaging cameras, LiDAR, sensors, etc., and data collected by the UAV(s) 305 describing the surroundings of the non-autonomous vehicles 309. As shown in FIG. 3, embodiments of the computing environment 300 can include one or more autonomous vehicle(s) 301, one or more UAV(s) 305, and/or an artificial intelligence (AI) system 310, placed in communication with one another via a network 102. Moreover, each of the one or more UAV(s) 305 that may be deployed to the surrounding environment, such as a roadway or highway to assist the autonomous vehicles 301, may be placed in communication with one or more of the non-autonomous vehicles 309. However, due to a lack of capabilities that may be available to some types of non-autonomous vehicles 309, a subset of non-autonomous vehicles 309 may be incapable of connecting to network 102 directly as shown in FIG. 3. Instead, communications between autonomous vehicles 301 and non-autonomous vehicles 309 may be performed using the UAV(s) 305 as an intermediary between the different types of vehicles.

Embodiments of autonomous vehicles 301 may be any type of vehicle capable of sensing its environment, navigating its surroundings and/or performing at least some (or all) tasks of vehicle operation without human input. Autonomous vehicles 301 can include cars, buses, trucks, construction vehicles, and/or any other type of vehicle or automobile. Autonomous vehicles 301, as referred to herein, may be any vehicle having level of automation from level 1 to level 5 (as described above in the Background section). In order to automate vehicle tasks or functions, embodiments of autonomous vehicles 301 may use a variety of sensors and scanning devices (such as camera systems or LiDAR) to perceive the environmental surroundings of the autonomous vehicle 301 and make decisions about how to navigate based on the collected data describing the surrounding the environment. The scanning devices and sensors of the autonomous vehicle 301 can collect data about the vehicle's surroundings including objects such as traffic lights, trees, curbs, pedestrians, street signs and other nearby vehicles. Collected data can be fed into machine learning models and/or neural networks and based on a mixture of sensor data and images collected from the various onboard devices scanning the surroundings of the autonomous vehicle 301, machine learning models and/or neural networks can identify the various objects surrounding the autonomous vehicle 301 as well as predict how objects or other vehicles might behave in real time. In some embodiments, an autonomous vehicle 301 may have a set of neural networks available to make driving decisions based on the incoming data being collected by the scanning devices and suite of sensors. Each neural network may be trained to dedicate itself to a specific task or function of the autonomous vehicle 301, with some amounts of overlap and redundancy between the different neural network tasks. For example, separate neural networks may be used to make driving decisions about the path of the vehicle, identification of road signs, steering, braking, accelerating, etc.

Devices and sensors used by the autonomous vehicle 301 for collecting data can include a combination of one or more different types of cameras and/or sensors positioned on the autonomous vehicle 301. For example, the cameras or sensors can include thermal imaging cameras, infrared cameras, radar sensors, LiDAR and other types of imaging devices or sensors. Imaging devices such as different types of camera systems may employ computer vision techniques to analyze and interpret visual environments surrounding the autonomous vehicle 301, allowing the vehicle to recognize different objects such as traffic lights, road signs, medians, pedestrians, trees, curbs and other vehicles on the roadway. Radar sensors may be any type of sensing device that may use radio waves to detect properties of the autonomous vehicle 301 and surrounding objects, including (but not limited to) properties such as distance, speed, and angle of objects around the autonomous vehicle 301. LiDAR sensors may use lasers to create a three-dimensional (3D) map of the vehicle's surrounding environment, helping the autonomous vehicle 301 understand the vehicle's location, layout of the roadway and other objects near the vehicle.

The imaging devices and/or sensors scanning the surroundings of the autonomous vehicles 301 may part of one or more modules onboard the autonomous vehicle 301 which may be responsible for collecting and interpreting the data of the surrounding roadway environment of the autonomous vehicle 301 using devices and sensor technologies described above, along with software for processing the collected information. The processing software can include machine learning algorithms, models, neural networks and/or other processing techniques to identify the surroundings of the vehicle and predict the best course of action (i.e., driving decisions) as autonomous vehicle 301 navigates through the surrounding environment, including steering, braking, accelerating, etc. The term “module” may refer to a hardware, software, or a module may be a combination of hardware and software resources. Embodiments of hardware-based modules may include self-contained components such as chipsets, specialized circuitry, one or more memory devices and/or persistent storage 113. A software-based module may be part of a program, program code or linked to program code containing specific programmed instructions loaded into a memory device or persistent storage 113 device of one or more computing systems 101 operating as part of the computing environment. As shown in FIG. 3, the module comprising the sensors, devices scanning surroundings and other technologies for collecting the data of the surrounding environment, along with the software components (including machine learning algorithms and neural networks) for processing the information and arriving at one or more driving decisions may be referred as scanning module 303.

Non-autonomous vehicle 309 may refer to any type of vehicle such as cars, trucks, buses, etc., that are unable to automate one or more driving functions or tasks of the vehicle without driver input. These non-autonomous vehicles may be referred to has being a level 0 autonomous vehicle, meaning they do not have autonomous capabilities and a human driver is entirely in control of all driving functions. However, not all non-autonomous vehicles 309 may be the same. Non-autonomous vehicles 309 may have different amounts of data collection capabilities, abilities to display or communicate data to a driver and/or connect to nearby vehicles or devices. Some autonomous vehicles may have limited data collection, display and alerting capabilities. For example, onboard camera systems and sensors may be able to display vehicle surroundings via a display device 313a-313n (referred to generally as display device 313) which may be integrated into the dashboard, console or HUD of the non-autonomous vehicle 309. Display device 313 may be capable of displaying video, including real-time video from rear and/or side view cameras, detect objects, pedestrians or other vehicles and/or display alerts or warnings as the non-autonomous vehicles 309 move too close to the object, person or vehicle being detected. In some embodiments, some non-autonomous vehicles 309 may include front-mounted or rear-mounted sensors which can detect distances between the non-autonomous vehicle 309 and may issue alerts that can emit noise or generate messages onto the display device 313 if the non-autonomous vehicle 309 is too close to another vehicle or the other vehicle is approaching too quickly. Moreover, some embodiments of non-autonomous vehicles 309 may be capable of establishing network connections with computing systems of surrounding vehicles and devices. For example, via Bluetooth, near-field communication and/or Wi-Fi.

It should be noted, that in some embodiments of computing environment 300, one or more non-autonomous vehicles 309 positioned within a driving environment may be incapable of conducting any data collection due to a lack of data collection capabilities (i.e., lack of imaging devices or sensors). Moreover, although not shown in FIG. 3, some non-autonomous vehicles 309 may not be equipped with any display device 313 such as a center console display system or HUD. Furthermore, while the non-autonomous vehicles of FIG. 3 are depicted as being disconnected from network 102, as noted above, instead communicating via UAV 305, as discussed above, some autonomous vehicles 309 may be equipped with capabilities to establish network connections or communication channels and therefore may be able to establish a direct connection with network 102, autonomous vehicle(s) 301 and/or UAVs 305 in some instances.

Embodiments of computing environment 300 may include an artificial intelligence (AI) system 310 depicted in FIG. 3. The AI system 310 is shown to be connected to network 102. The AI system 310 may be readily accessible by autonomous vehicle 301 and/or UAV 305. Embodiments of AI system 310 may maintain a knowledge corpus 311 (also known as a “knowledge base”). The knowledge corpus 311 may be a store of information or data that the AI system 310 can draw on to solve problems and find solutions. For example, solving problems and finding solutions for autonomous vehicles 301 and/or UAVs 305 with regards to the identification of non-autonomous vehicles 309 within a driving environment having particular attributes or capabilities, classifications of vehicles within a driving environment as autonomous vehicles 301 or non-autonomous vehicles 309 based on images and license plate recognition or other methods and/or predicting a number of UAVs 305 to dispatch to a driving environment that optimally assists autonomous vehicles 301 with navigating a roadway or other driving environment. The knowledge corpus 311 can include an underlying set of facts, ground truths, assumptions, models, derived data and rules upon which AI system 310 has available in order to solve the problem of dynamically deciding which vehicles should be assisted with UAVs 305, and the kinds of features that should be attached to the non-autonomous vehicles so that other vehicles co-located on the roadway or other driving environment can maximize collaboration. AI system 310 can flexibly assign UAV's or enable UAV 305 functions depending on performance levels and capabilities of the types of vehicles identified within the driving environment.

Knowledge corpus 311 and records thereof, can be created by inputting historically collected data directly into the knowledge corpus 311 by user or administrator in some embodiments. In other embodiments or instances, creation of the knowledge corpus 311 and records thereof, may occur by ingesting collected data provided by one or more data sources. For example, images and sensor data being transmitted from autonomous vehicles 301 and UAVs 305 to the AI system 310. The collected data from the UAVs 305 and autonomous vehicle(s) 301 that is being ingested by the knowledge corpus 311 may be in the form of any type of file, text, image, video or other source of data (structured or unstructured) for use within the AI system 310. The corpus of content may be provided in the form of electronic documents, files and/or multimedia, and may be accessed by the AI system 310 via a network connection or internet connection to network 102. AI system 310 may fetch the collected data for creating and/or updating the knowledge corpus 311 from one or more of the data source(s) being inputted into AI system 310 and the data can be routed through the network 102 as shown in FIG. 3. Embodiments of AI system 310 may operate in environments of any size, including local and global (e.g., the Internet). Additionally, AI system 310 can serve as a front-end system that can make available a variety of knowledge extracted from, or represented in documents, network-accessible sources and/or structured data sources, to one or more applications 150 or programs, such as transportation service 350. In this manner, some processes populating the AI system 310 may also include input interfaces to receive output from the knowledge corpus 311 and respond accordingly.

Embodiments of AI system 310 may include an AI engine 312. The AI engine 312 may be an interconnected and streamlined collection of operations. Information being inputted into AI system 310 may work its way through a machine learning system (i.e., from data collection to model training). During data collection (such as ingestion of data from the plurality of autonomous vehicles 301 or UAV 305) data can be transported from multiple data sources and into a centralized database stored in knowledge corpus 311. From the knowledge corpus 311, AI engine 312 can access, analyze and use the data stored by the knowledge corpus 311. For example, AI engine 312 can analyze data collected from autonomous vehicles 301 and UAVs 305 describing the surrounding driving environment of vehicles and based on the types of vehicles within a driving environment, the ratio of autonomous to non-autonomous vehicles, roadway conditions, environmental conditions (including weather events) the relative positioning of different autonomous vehicles 301 and non-autonomous vehicles 309, and/or historically observed patterns from collected data, AI engine 312 can determine the number of UAVs 305 to dispatch, which non-autonomous vehicles 309 to assign to UAVs 305, and which type of technological capabilities of UAVs 305 to implement within the driving environment.

Models 316 may be the output and result of AI modeling using the data collected from the autonomous vehicles 301 and/or UAV's 305. AI modeling may refer to the creation, training and deployment of machine learning algorithms that may emulate decision-making based on data available within the knowledge corpus 311 of the AI system 310 and/or using data that may be available outside of the knowledge corpus 311. The AI models 316 may provide the AI system 310 with a foundation to support advanced intelligence methodologies, such as real-time analytics, predictive analytics and/or augmented analytics, which can be utilized when identifying non-autonomous vehicles 309 within a driving environment and capabilities thereof, selecting a number of UAVs 305 to deploy to a specific driving environment, determining which non-autonomous vehicles are assigned to a UAV 305 based on the attributes and parameters of the current driving environment and the capabilities of the UAV 305 to enable based on the type of non-autonomous vehicle 309 being supported.

User interface 314 may refer to an interface provided between AI system 310 and human users. For example, end users operating an autonomous vehicle 301 can interface with AI system 310 and applications or services thereof, such as transportation service 350 to request UAV support when the autonomous vehicle 301 is experiencing difficulties making driving decisions within the current driving environment. The user interface 314 utilized by AI system 310 may be a command line interface (CLI), menu-driven interface, graphical user interface (GUI), a touchscreen GUI, etc. Programs and applications 150 provided by AI system 310, such as transportation service 350, may include any type of application that may incorporate and leverage the use of artificial intelligence to complete one or more tasks, operations or functions. Examples of different types of applications that may leverage the AI capabilities of the AI system 310 and can include search engines, recommendation systems, virtual assistants, language translators, facial recognition, image labeling systems, question-answering systems, transportation services 350 and combinations of applications thereof.

Transportation service 350 may be an application, service or program which may provide UAV 305 support to autonomous vehicles 301 operating within a driving environment that may be having difficulty collaborating and/or coordinating driving actions alongside non-autonomous vehicles 309 within the driving environment. In some embodiments, transportation service 350 may be a service or application that is hosted or provided by AI system 310 (as shown in the embodiment of FIG. 3). In other embodiments, transportation service 350 may be hosted by a separate computer system 101 that may be placed in communication with AI system 310 via a network 102. Transportation service 350 may include one or more components or sub-components that may perform one or more specific tasks or functions of transportation service 350. These components of transportation service 350 may leverage the use of one or more components of AI system 310 while performing the functions and tasks of transportation service 350. Components of transportation service 350 may include a data collection module 501, classification engine 505, prediction engine 507 and/or a UAV dispatch module 509.

Data collection module 501 may perform the tasks or functions of the transportation service 350 which may be associated with gathering and/or storing data produced by autonomous vehicles 301 and/or UAVs 305. For example, data collection module 501 may request and receive image data, LiDAR data and/or other sensor data captured by scanning module 303, including data describing the environmental surroundings of the autonomous vehicle 301 as well as images of nearby vehicles (both autonomous and non-autonomous). Moreover, data collection module 501 may further gather image data, LiDAR and sensor data from UAVs 305 that may be deployed to a driving environment. Data streams from the UAV 305 comprising the image, sensor, LiDAR and other data captured by the UAV 305 while assigned to a non-autonomous vehicle may be transmitted to the data collection module 501. Data received by the data collection module 501 may be stored to the data collection module 501 itself, the knowledge corpus 311 and/or another storage device of a computing system 101 hosting the transportation services 350, such as AI system 310.

Embodiments of classification engine 505 may perform tasks or functions of the transportation service 350 which may be associated with identifying and classifying the types of vehicles within a driving environment surrounding one or more autonomous vehicles 301. Identification and classification can be based on the data captured by the autonomous vehicles 301 that is being provided to the transportation services 350. Embodiments of classification engine 505 leverage the knowledge corpus 311, AI engine 312 and associated models 316 to identify makes and models of vehicles that are present within a driving environment, classifying the vehicle as an autonomous vehicle 301 or non-autonomous vehicle 309. For example, in some embodiments the classification engine 505 may be capable of reading known license plate information and comparing the known license plate information with data stored by the knowledge corpus 311 to identify makes and models of vehicles using publicly available registration information. Once makes and models of vehicles are known, certain makes and models may historically be classified and/or publicly marketed as autonomous vehicles 301 and thus, the classification engine 505 may be able to label each of the identified vehicles as an autonomous vehicle 301 or non-autonomous vehicle 309.

Furthermore, in some embodiments, classification engine 505 may additionally classify non-autonomous vehicles 309 based on additional capabilities of the vehicle. For instance, once a make and model of the non-autonomous vehicle 309 is identified from the data collected by autonomous vehicles 301 positioned within the driving environment, additional product specifications may be searched or stored about various vehicle models, packages and upgrades that might be associated with specific vehicle model or vehicle package. Using known product specifications for the identified make and model of the non-autonomous vehicles 309, classification engine 505 may further classify the non-autonomous vehicles 309 based on additional known capabilities. For example, classifying whether non-autonomous vehicles 309 are equipped with networking or wireless communication capabilities (such as Bluetooth or Wi-Fi), the types of data collection systems and sensors that might be onboard the non-autonomous vehicle 309, and/or the presence of a HUD, augmented reality glass, alert system, touch screen display or any other type of display device 313 within the vehicle.

Prediction engine 507 of transaction service 350 may leverage the AI system 310 to perform functions or tasks associated with predicting a number and/or type of UAVs 305 to dispatch to a driving environment in response to a request for UAV 305 support by one or more autonomous vehicles 301 within the surrounding environment of the roadway or highway. When making a prediction about the number and type of UAVs 305 to dispatch in response to a request, the prediction engine 507 may predict an appropriate number of UAVs 305 and type of UAVs 305 to dispatch for specific scenarios within a driving environment based on several potential factors. For example, the prediction engine 507 may consider (among other factors) the total number non-autonomous vehicles 309, a ratio of non-autonomous vehicles 309 to autonomous vehicles 301, known data collection, communication and alerting capabilities of each of the non-autonomous vehicles 309, roadway conditions, environmental conditions, historical conditions and/or historical scenarios that were successfully supported with UAVs previously. In some embodiments, certain factors may be assigned more weight in the prediction process than others. Taking into consideration each of the factors and associated weights, the prediction engine 507 may use the AI system 310 to output a decision on the total number of UAVs to deploy, the types of UAVs 305 to deploy, and which non-autonomous vehicles 309 positioned within the driving environment are assigned to receive support from a UAV 305. Moreover, as the driving environment dynamically changes, and new data collected by autonomous vehicles 301 are provided to transportation service 350 over time, prediction engine 507 may dynamically change predictions. For example, changing the predicted number of UAVs 305 to deploy, and which UAVs 305 to assign to the different autonomous vehicles 309 that are added to or remaining within the driving environment.

Embodiments of the transportation service 350 may comprise a UAV dispatch module 509. The UAV dispatch module 509 may be responsible for communicating instructions to the one or more UAVs 305 that may be present within a fleet of UAVs and accessible for use by the transportation service 350. Instructions provided by the UAV dispatch module 509 may reflect the predictions outputted by prediction engine 507. For instance, UAV dispatch module 509 may dispatch to a driving environment the number and type of UAVs 305 prescribed by the prediction engine 507 and assign specific UAVs 305 to non-autonomous vehicles 309 identified by the prediction engine 507 as needing UAV support. Embodiments of UAV dispatch module 509 may provide UAVs 305 with location data describing the driving environment being serviced, as well as identify the autonomous vehicle(s) 301 requesting assistance. UAV dispatch module 509 may remotely approve or enable UAVs 305 assigned to a particular driving environment for flight, and upon changes in the recommendations of the prediction engine 507 and/or completion of the support request, the UAV dispatch module 509 may recall UAVs 305 to return to a designated home base, dispatch additional UAVs 305 to meet the updated recommendations and/or reassign UAVs 305 to a new driving environment location requesting support.

Embodiments of UAVs 305 being dispatched by the UAV dispatch module 509 may be any type of unmanned aerial vehicle that may be piloted via remote control, onboard computer systems 101 or a combination of inputs thereof. A UAV 305 may include drones which may have autonomous flight capabilities and may be able to operate without any human intervention. UAVs 305 being dispatched to a driving environment to provide support may not all be identical types of aerial vehicles. In some instances, there may be a plurality of different UAVs 305 which may have different types of capabilities, functions and features and assignment of the different types of UAVs 305 may vary depending on the various conditions of the driving environment and the types of vehicles present on the roadway or highway of the surrounding environment. Embodiments of the components comprising the scanning and projection modules 307 of the UAV 305 may differ between UAVs 305 depending on the make and model of the UAV 305. For example, the types of UAVs 305 being dispatched to support vehicles positioned within a driving environment, may be equipped with different types and/or combinations of scanning devices 551, sensors 552, projection devices 555 and/or UAV attachment systems 557.

Referring to the drawing of FIG. 5B, a block diagram of an exemplary embodiment of a scanning and projection module 307 of a UAV 305 is shown. As shown, in the figure, the scanning and projection module 307 may comprise one or more scanning device 551, a suite of one or more sensor(s) 552, a communication module 553, projection device 555 and/or a UAV attachment system 557. A scanning device 551 may refer to one or more devices or systems capable of scanning the surrounding environment of the UAV 305, capturing data or information about the surrounding environment from the UAV's 305 position within the environment. An example of a scanning device 551 may include a camera system such as digital camera, infrared camera, thermal camera, etc. Scanning device 551 may be 2-D or 3-D cameras and may incorporate the use of one or more sensor(s) 552 described herein, during operation. Sensors 552 equipped by the 305 may include image sensors, radar sensors and/or LiDAR system. Image sensors may be described as a device that may allow for cameras being used as scanning devices 551 on the UAV 305 to convert photons (i.e., light) into electrical signals that can be transformed into binary values that can be processed and stored. Radar sensors may be a type of sensor 552 that may use wireless technology to detect motion around the UAV 305 and assist with figuring out positions of objects (including autonomous vehicles 301 and non-autonomous vehicles 309), shapes, motion characteristics, velocities and trajectories. A LiDAR system may be considered a scanning device 551, a sensor 552, or a combination thereof. LiDAR may be described as a detection system that works using similar principles as radar, except instead of radio waves, LiDAR uses light emitted from a laser which is reflected off objects and based on the time of flight of the laser being reflected back, distances of objects can be constructed into a 3D map of the surrounding environment.

Communication module 553 may perform the tasks and functions of the scanning and projection module 307 that may be directed toward establishing a channel of communication between one or more autonomous vehicles 301 and/or one or more non-autonomous vehicles 309 that may have such communication capabilities. In some embodiments, the communication module 553 may facilitate communication with autonomous or non-autonomous vehicles (where applicable) via network 102. In other embodiments, a UAV's communication module 553 may pair itself with nearby autonomous vehicles 301 (and in some instances non-autonomous vehicles 309 with such capabilities) using a short range communication protocol to exchange a transfer data, messages, alerts, etc. Examples of short range communication protocols that may be used by the communication module 553 of a UAV 305 may include infrared, Bluetooth (802.15.1), Bluetooth LE, Zigbee (802.15.4), Wi-Fi (802.11a/b/g/n/a/ax), near-field communication (NFC) etc. Data collected by the UAV 305 about the surroundings of the environment of the non-autonomous vehicle 309 assigned to the UAV 305 can be shared by the communication module 553 with nearby autonomous vehicles 301 and/or other UAVs 305 in the environment that may be paired with the UAV 305 sharing the data collected by one or more scanning device 551 and/or sensors 552. Moreover, autonomous vehicles 301 paired with a UAV 305 may share driving decisions outputted by autonomous vehicles 301, enabling the UAV 305 to further share the driving decisions with non-autonomous vehicles 309 assigned to the UAV.

Projection device 555 of the scanning and projection module 307 may perform the functions or tasks associated with facilitating and sharing communications with non-autonomous vehicles 309 that may be otherwise incapable of receiving communications from autonomous vehicles 301. Projection devices 555 may share communications such as driving decisions of autonomous vehicles 301 using mediums such as light and lasers to generate images and text. In the exemplary embodiment, the projection device 555 of a UAV 305 may laser or light project driving decisions of nearby autonomous vehicles onto the windshield or HUD of non-autonomous vehicles 309. In other embodiments, the projection device may display the driving decisions of the nearby autonomous vehicles 301 onto augmented reality glass positioned within the non-autonomous vehicle 309 and/or in possession of the driver or passenger of the non-autonomous vehicle 309.

Embodiments of UAV attachment system 557 may be described as a device, mechanism, hardware and/or accompanying software that is capable of receiving or attaching a UAV 305 to a vehicle within a driving environment. More particularly, attaching the UAV 305 to the non-autonomous vehicle 309 assigned to be supported by the UAV 305 being attached thereto. The UAV attachment system 557 may comprise a suction device, magnetic attachment, locking mechanism or other type of hardware for securing the UAV 305 to a vehicle. In the exemplary embodiment, the UAV attachment system 557 may utilize a suction system to create vacuum pressure, allowing the UAV 305 to land on the vehicle and using the force of the UAV 305 generate a vacuum that may hold the UAV 305 in place atop of a non-autonomous vehicle 309.

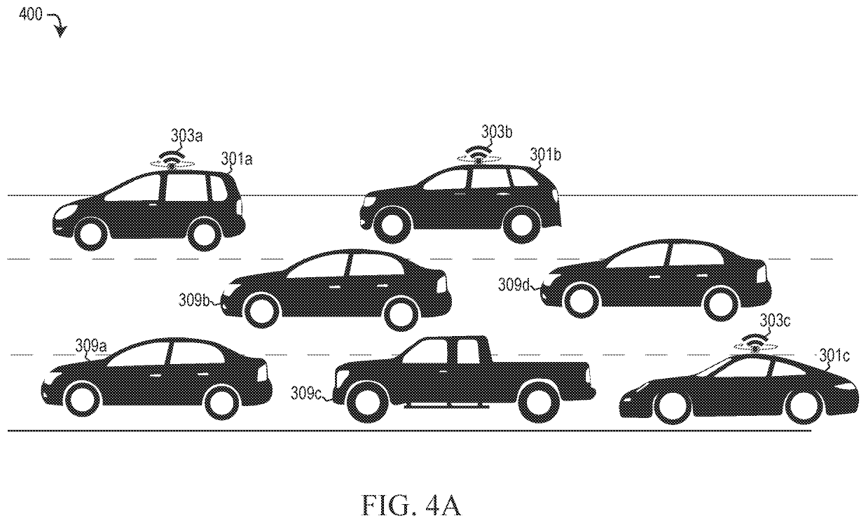

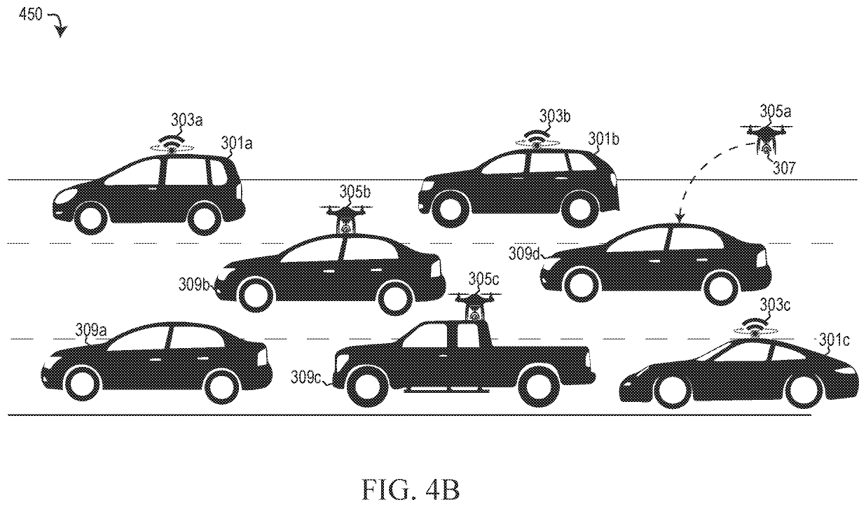

FIG. 4A-4B illustrate an example of a driving environment 400, 450 comprising a plurality of autonomous vehicles 301a-301c and non-autonomous vehicles 309a-309d operating side-by-side within a surrounding environment of a roadway or highway. As shown in FIG. 4A, the plurality of autonomous vehicles may be equipped with a scanning module 303a-303c which may comprise a plurality of scanning devices 551 and/or sensors 552 similar to those that may be equipped by UAVs 305. While the autonomous vehicles 301a-301c are driving along the driving environment 400, the scanning modules 303a-303c of the autonomous vehicles 301a-301c may be gathering data describing the driving environment 400, including nearby autonomous vehicles 301a-301c and non-autonomous vehicles 309a-309d, roadway conditions, nearby objects or hazards, in order to predict driving patterns of all the vehicles on the roadway, and attempt to output driving decisions in response to predicted driving patterns of the other vehicles. For example, in an exemplary embodiment, the scanning module 303a-303c may scan the surroundings of the driving environment using a portable LiDAR system, sensors and/or one or more imaging devices such as a camera to identify the each of the types of vehicles and objects presently surrounding the autonomous vehicles 301a-301c. Collected data transmit can be transmitted to the transportation services 350, where it can be stored and used to make decisions about the driving environment 400.

In response to one or more autonomous vehicles 301a-301c experiencing difficulties collaborating with nearby vehicles (more specifically unable to collaborate with non-autonomous vehicles 309a-309d), difficulties being able to predict driving patterns of other vehicles and/or difficulties outputting accurate driving decisions due to the presence of non-autonomous vehicles 309a-309d, one or more autonomous vehicles 301a-301c may request support from transportation services 350. As part of the request for support one or more UAVs 305 may be dispatched by transportation services 350 based on the optimal configuration and number of UAVs 305 predicted by predicted engine 507. FIG. 4B depicts the driving environment 450 which illustrates a response to a request for UAV 305 support by at least one autonomous vehicle 301a-301c. As shown, in this embodiment, transportation services 350 dispatches three UAVs 305a-305c based on the parameters and conditions of the driving environment 450. In this particular example, transportation services 350 predicted that it was not necessary for every single non-autonomous vehicle 309a-309d to receive UAV support. However, in a driving situation with different parameters or conditions, transportation services 350 might choose to assign a UAV 305 to each non-autonomous vehicle 309 present within a driving environment 400.

As shown in FIG. 4B, each of the UAVs 305a-305c are assigned to a non-autonomous vehicle 309b-309d. In this particular example, UAV 305b-305c land on top of their assigned non-autonomous vehicles 309b and 309c using a UAV attachment system 557 of the scanning and projection module 307. UAV 305a on the other hand remains in flight and monitors the surroundings of non-autonomous vehicle 309d from the air in this embodiment. Once positioned either attached to an assigned vehicle or above the assigned vehicle, UAVs 305a-305c can connect or pair with autonomous vehicles 301a-301c via communication module 553 and begin scanning the driving environment 450 using one or more components of scanning and projection module 307; capturing image data and sensor data that can be used by the autonomous vehicles 301a-301c paired with the UAVs 305a-305c, to making driving decisions and communicate said driving decisions with non-autonomous vehicles 309b-309d. As driving decisions are made by one or more of the nearby autonomous vehicles 301a-301c, the decisions being made can be transmitted via a network or dedicated data channel created when the UAVs 305a-305c paired with the autonomous vehicles 301a-301c.

As the driving decisions are received by each UAV 305a-305c, each UAV 305a-305c may display the driving decisions in a manner that can be seen by the non-autonomous vehicle 309b-309d assigned to said UAV 305a-305c. For example, in the driving environment 450 shown in FIG. 4B, UAV 305b displays driving decisions from the surrounding autonomous vehicles 301a-301c to non-autonomous vehicle 309b; whereas UAV 305a displays the driving decisions to non-autonomous vehicle 309d and UAV 305c displays driving decisions to non-autonomous vehicle 309c. Displaying the driving decisions to an assigned non-autonomous vehicle 309b-309d, may be performed by the projection device 555 of the scanning and projection module 307. As discussed above, the projection device 555 can use light or lasers to project driving decisions of the surrounding autonomous vehicles 301a-301c on the windshield of the non-autonomous vehicles 309b-309d in some instances. In other instances, projection device 555 may transmit the driving decisions to a HUD of the non-autonomous vehicle 309b-309d, a display device within the vehicle, augmented reality glass or device positioned within the vehicle, and/or a mobile communication device or other network accessible device that the communication module 553 of the UAV 305 may be able to pair with that is inside of the assigned non-autonomous vehicle 309b-309d.

The collaboration between the UAVs 305a-305c scanning the driving environment 450, the autonomous vehicles 301a-301c making driving decisions based on the collected UAV data (in addition to the autonomous vehicle's own gathered data), and the UAVs 305a-305c guiding the non-autonomous vehicles 309b-309d using projections of driving decisions onto the windshield, HUD or other display device 313, may be performed as edge computations. Edge computing is a method of processing data and running applications as close to the source of the data as possible (i.e., the UAVs 305 and autonomous vehicles 301), rather than sending all the data to a centralized data center or cloud for processing, such as AI system 310. Edge computing allows data to be processed at the edge of the network 102, closer to the UAVs 305a-305c and autonomous vehicles 301a-301c that generate data. By making the computations at the edge of the network, this reduces the amount of data that needs to be sent back to AI system 310 for processing. In other words, the computations and collaboration between the UAV 305a-305c and autonomous vehicles 301a-301c may be happening on-site at the driving environment, rather than relying on a centralized server or the cloud to process the data and return the information to the UAVs 305a-305c for the purpose of displaying the driving decisions. This can improve the efficiency, performance, and responsiveness of UAV 305 and autonomous vehicles 301 because guidance of the non-autonomous vehicles 309b-309d are occurring in real-time.

UAVs 305a-305c may continuously capture information about the surrounding driving environment 450, transmit said collected information to the nearby autonomous vehicles 301a-301c and provide the driving decisions of the autonomous vehicles 301a-301c being made using the collected information of the UAVs 305a-305c until one or more conditions within the driving environment change. For example, the driving environment 450 may change as vehicles enter or leave the driving environment 450. Such addition or subtraction of vehicles may result in the addition, subtraction or reassignment of UAVs 305 within the surrounding environment, per the orders of the transportation services 350 monitoring the driving environment 450. As UAVs 305 are removed from the driving environment 450 or reassigned, the UAVs 305 may detach from their assigned non-autonomous vehicle 309, take flight and either leave the driving environment 450 or re-attach to new non-autonomous vehicle 309. Moreover, as driving conditions and parameters within the driving environment change, UAV support may no longer be necessary. In response to UAVs 305 no longer being necessary to support the autonomous vehicles 301 within the driving environment 450, transportation services 350 may reassign one or more UAVs 305 to a new driving environment that has requested assistance or recall the UAVs 305 to return to a home base. Upon request to reassign or recall to a home base, UAVs 305 that are attached to a non-autonomous vehicle 309 may detach the UAV attachment system 557, take flight and fly to the next location of either the new driving environment or the home base.

### Method for Enabling Communication And Collaboration Between Autonomous And Non-Autonomous Vehicles

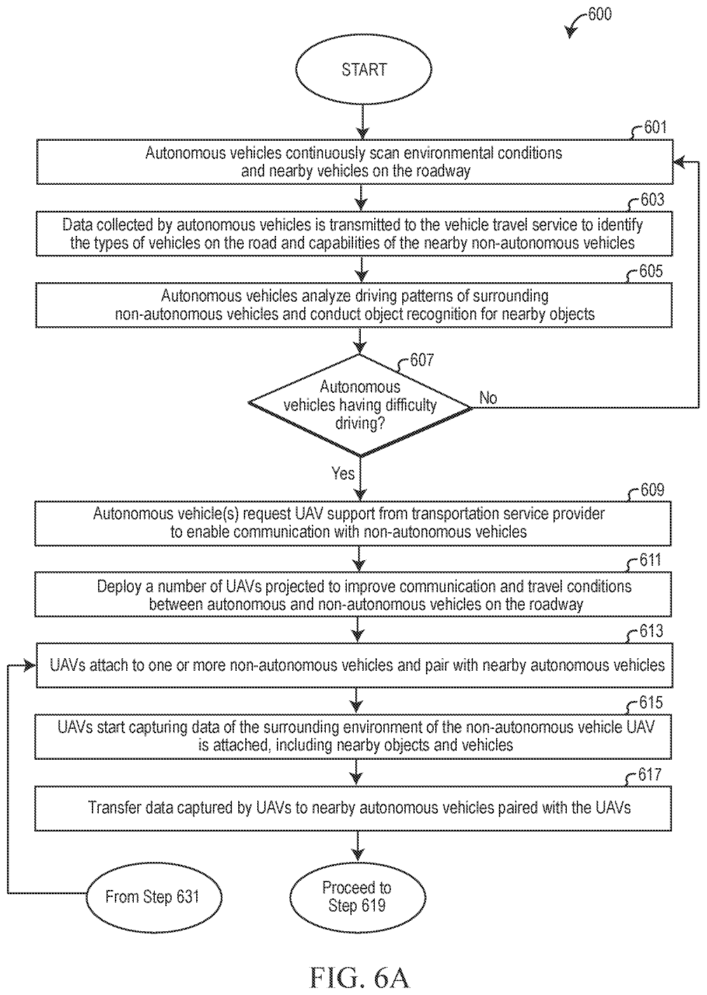

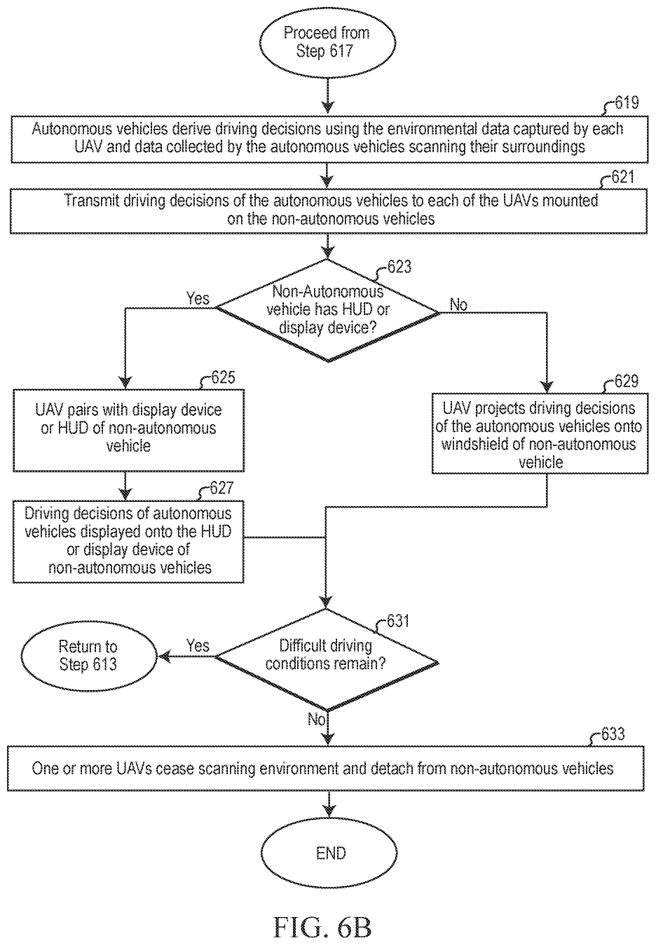

The drawings of FIGS. 6A-6B represent an embodiment of method 600 for enabling communication and collaboration between autonomous vehicles 301 and non-autonomous vehicles 309. The embodiments of method 600 can be implemented in accordance with the computing systems and examples depicted in FIGS. 1-5B above and as described throughout this application. A person skilled in the art should recognize that the steps of the method 600 described in regard to FIGS. 6A-6B may be performed in a different order than presented and may not require all the steps described herein to be performed.

The embodiment of method 600, as shown and described in FIG. 6A, may begin at step 601. During step 601, autonomous vehicles 301 traveling along a roadway, highway or other type of environment surrounding the vehicle may continuously scan the autonomous vehicle's environmental surroundings using one or more technological capabilities available to the autonomous vehicle 301 (for example via scanning module 303), including but not limited to thermal imaging, infrared imaging, LiDAR, and a suite of sensors 552. During the scan of the environmental surroundings of the autonomous vehicle 301, the autonomous vehicle may collect data about the surrounding environment including the capture of data and imaging of nearby objects, roadway conditions and nearby vehicles (both autonomous and non-autonomous).

In step 603, the stream of data being captured by the scanning module 303 of the autonomous vehicle 301 may be transmitted and/or shared with the AI system 310 and/or transportation service 350 of the AI system 310. Using the data collected by the autonomous vehicles 301 that are positioned within the surrounding environment, the AI system 310 may classify the types of vehicles present on the roadway near the autonomous vehicles 301 submitting the captured data of the surrounding environment. For example, using license plate recognition from images taken by an autonomous vehicle 301, AI system 310 may determine the make and model of the vehicle belonging to the registered license plate and once the make and model are determined, vehicle information describing the capabilities of the vehicle can be identified. For instance, the make and model of the registered vehicle may indicate whether the vehicle is autonomous or not, the type of communication hardware or software available, the capabilities of the vehicle to gather information about the vehicle's surrounding environment, decision making capabilities of the vehicles, the types of systems available to display alerts or information to the driver and other specifications.

In step 605, autonomous vehicles 301 operating within the roadway environment may analyze the driving behaviors of the non-autonomous vehicles 309 that are present on the roadway based on the collected data from the scanning device(s) 551 and/or sensor device(s) 552. Based on the analysis of the driving behaviors, autonomous vehicle(s) 301 may attempt to predict driving patterns of non-autonomous vehicles 309 and/or make autonomous driving decisions using the data collected by the scanning device(s) 551 and sensor(s) 552 of the autonomous vehicle 301, despite a lack of ability to communicate and collaborate driving decisions with the non-autonomous vehicles 309. In step 607, an assessment is made by method 600 whether or not the autonomous vehicles 301 driving along the roadway environment are having difficulty making driving decisions and/or navigating the roadway alongside the non-autonomous vehicles 309 without being able to communicate. If autonomous vehicles 301 are not having difficulties driving within the roadway environment as the environment currently exists, the method may return to step 601, whereby the autonomous vehicles 301 may continue to scan the environmental conditions of the roadway as well as the nearby surrounding vehicles and make driving decisions. Conversely, if in step 607 one or more autonomous vehicles 301 operating within the surrounding roadway environment is having difficulty making accurate driving decisions or navigating along the roadway due to a lack of communication with non-autonomous vehicles 309 that are present, the method 600 may proceed to step 609.

During step 609 of method 600, the one or more autonomous vehicles 301 having difficulties driving along the roadway environment and/or difficulty making accurate driving decisions may transmit a request to receive support from one or more UAVs 305, in order to enable communication between autonomous and non-autonomous vehicles. In the exemplary embodiment, the one or more autonomous vehicles 301 may transmit the request for UAV 305 support to a transportation service 350. In step 611, the transportation service 350 may deploy a requisite number of UAVs 305 determined, based on the current driving scenario being experienced along the roadway environment. In making a decision on the number or type of UAVs 305 to deploy, the transportation service 350 may take into consideration a number of factors about the environment (as determined from the data received from the autonomous vehicles in step 603) including (but not limited to) the composition or ratio of autonomous to non-autonomous vehicles, the types of non-autonomous vehicles 309 positioned along the roadway, the non-autonomous vehicles' know capabilities, and/or conditions of the roadway environment (including weather conditions and/or state of the roadway itself). Based on the factors describing the current situation of the roadway environment, the transportation service 350 may deploy an appropriate number of UAVs 305 to the roadway to assist the autonomous vehicles 301.

In step 613, the deployed UAVs 305 arriving within the vicinity of the autonomous vehicle(s) 301 making the request for assistance, may be assigned by the transportation service 350 to scan and capture data surrounding one or more non-autonomous vehicles 309. The UAVs 305 may hover above their assigned non-autonomous vehicle 309 in some embodiments. In other embodiments, the UAVs may physically attach themselves to the non-autonomous vehicle 309 the UAV 305 is assigned using a UAV attachment system 557 of the UAV 305. For example, the UAV may attach using an interconnecting mechanism that locks the UAV 305 to the non-autonomous vehicle 309, attach using a magnetic connector, attach using a suction device or other type of attaching mechanism that may create a vacuum using pressure as the UAV 305 touches down onto the non-autonomous vehicle 309; preventing the UAV 305 from falling off of the non-autonomous vehicle 309 while it is in motion. Additionally, the UAVs 305 may establish a connection with nearby autonomous vehicles 301. For instance, by pairing themselves with the autonomous vehicle 301, creating a dedicated channel for sending and receiving data between each of the autonomous vehicles 301 and the UAV 305.

In step 615, each of the UAVs 305 attached or hovering above an assigned non-autonomous vehicle 309 may begin scanning the surrounding area using one or more components of the onboard scanning and projection module 307. For example, by using one or more scanning device 551 such as LiDAR and/or the suite of sensor(s) 552 of the UAV 305 to capture data of the surrounding roadway environment, including nearby objects, roadway hazards, environmental hazards and/or nearby vehicles (both autonomous and non-autonomous). During step 617 of method 600, the UAV 305 may transfer the data being captured by the scanning and projection module 307 and transfer a copy of the collected data to each of the autonomous vehicles 301 having an established connection with the UAV 305. In step 619, each of the autonomous vehicles 301 may utilize the captured data provided by the UAV 305 in combination with data captured by the autonomous vehicle 301 to more accurately predict the driving patterns of the non-autonomous vehicles 309 and generate accurate driving decisions that each autonomous vehicle 301 intends to implement.

In step 621, the autonomous vehicles 301 operating within the roadway environment may transmit the driving decisions outputted by autonomous vehicles in step 619 to each of the UAVs 305 that are placed in communication with the autonomous vehicles, via an established network connection. The UAV 305 may be tasked with displaying or providing the intended driving decisions of the autonomous vehicles 301 to the non-autonomous vehicles 309. However, the method by which UAV provides the driving decisions of the autonomous vehicles 301 to the non-autonomous vehicle 309 may differ depending on the type of the non-autonomous vehicle 309 and the technological capabilities of the non-autonomous vehicle 309. For example, whether or not the non-autonomous vehicle 309 is equipped with a display device 313 built into the vehicle, such as one integrated into the dashboard, an onboard HUD or augmented reality glass which can display driving decisions onto the windshield for the driver to view and/or a mobile communications device within the non-autonomous vehicle which can connect with and communicate directly with the UAV 305.

In step 623 of method 600, a determination is made whether or not the type of the non-autonomous vehicle 309 that the UAV 305 is connected to is equipped with a display device 313, HUD or other communication device capable of displaying the driving decisions of the autonomous vehicles 301. If the non-autonomous vehicle 309 is equipped with a display device 313, HUD or some other communication device capable of displaying driving decisions of the autonomous vehicle 301, which may include mobile devices on the person of driver or passengers within the vehicle, the method 600 may proceed to step 625. During step 625, the UAV 305 may establish a channel of communication with the display device 313, HUD or other available communication device within the non-autonomous vehicle 309. For example, by pairing with device, such as via a Bluetooth or Bluetooth LE (low energy) communication protocol. Once a communication channel is established with a display device 313 or HUD of the non-autonomous vehicle 309 and/or a driver or passenger within the non-autonomous vehicle 309, the method may proceed to step 627, whereby UAV 305 transmits, and the display device 313 or HUD connected to the UAV 305 displays, the driving decision of the autonomous vehicle(s) 301 of the surrounding roadway environment.

Referring back to step 623 of method 600, wherein a decision is made by the UAV 305 whether or not the non-autonomous vehicle 309 has capabilities of directly receiving the driving decisions of the autonomous vehicle 301 from the UAV 305 via a display device 313 or HUD within the non-autonomous vehicle 309. If the non-autonomous vehicle 309 is not equipped with a display device 313 or HUD and/or none of the passengers or driver is equipped with a device capable of receiving the driving decisions of the autonomous vehicle 301 from the UAV 305, the method 600 may proceed to step 629. During step 629, the UAV 305 may project the driving decisions of the autonomous vehicles 301 onto the windshield of the non-autonomous vehicle 309. For example, by using a projection device 555 of the UAV 305 such as a laser projector or light projection system which can form images, videos, animations, text etc. onto the windshield of the non-autonomous vehicle 309 that can be viewable by the driver and/or passengers of the non-autonomous vehicle 309. As a result of receiving the driving decisions being displayed onto the windshield of the non-autonomous vehicle 309, the driver and/or passengers of the non-autonomous vehicle 309 become alerted and/or aware of the upcoming actions being taken by the autonomous vehicles 301 positioned along the roadway of the surrounding environment and in response the driver of the non-autonomous vehicle 309 can anticipate movements by the autonomous vehicle 301 and coordinate driving patterns of the non-autonomous vehicle 309 in anticipation of the upcoming decisions and movements, thus providing collaboration between all vehicles on the roadway despite technological differences between the different types of vehicles.

During step 631 of method 600, the conditions of the driving environment and the ability of the autonomous vehicles to make accurate driving decisions alongside the non-autonomous vehicles 309 may be re-assessed periodically while the autonomous vehicles 301 continue to operate along the roadway environment as roadway conditions may change or evolve due to the changing composition of vehicles traveling along the roadway and/or the presence of roadway hazards or obstacles that may be presented at certain points along the roadway may change and subside over time. During step 631, a determination may be made by autonomous vehicles 301 traveling within the roadway environment being assisted by one or more UAVs 305 whether or not the difficult driving conditions remain that require the continued assistance of the UAVs 305. If difficult driving conditions remain which indicate that support of UAVs 305 should continue, the method 600 may return to step 613 whereby the UAVs 305 may remain positioned along the roadway environment and continue to collect data about the surrounding environment and each UAV's 305 assigned non-autonomous vehicle; however, UAVs 305 assignments and positions may be dynamically changed. UAVs may remain as currently positioned on or around one or more autonomous vehicles 309, UAVs 305 may reposition themselves based on the changes in composition or difficulties of the roadway environment, UAVs may be reassigned to one or more different non-autonomous vehicles 309, or a change in a number of UAVs 305 deployed to support the roadway environment may occur by either increasing or decreasing the number of UAVs 305 assigned to provide support.

Conversely, if in step 631 a determination is made that the difficult driving conditions that resulted in the initial request for UAV 305 support no longer remain within the surrounding roadway environment, the method 600 may proceed to step 633 wherein one or more UAVs 305 assigned to support the vehicles traveling along the roadway may cease scanning the environment. The UAVs attached to the non-autonomous vehicles 309 may detach from the assigned non-autonomous vehicles 309, take flight and exit from the roadway environment. The UAVs 305 being removed from the roadway environment may be available for assignment to a new location and therefore engage a flight trajectory toward the new location, or the UAVs 305 may be instructed to return to a home base and await the next deployment.

What is claimed is:

1. A computer-implemented method of enabling collaboration between autonomous vehicles and drivers of non-autonomous vehicles, the computer-implemented method comprising:
deploying an unmanned aerial vehicle (UAV) to an environment comprising the autonomous vehicles and the non-autonomous vehicles driving on a roadway;
attaching the UAV to one or more of the non-autonomous vehicles;
pairing the UAV with one or more of the autonomous vehicles within the environment;
scanning, by the UAV, the environment and vehicles surrounding the UAV attached to one or more non-autonomous vehicles;
transmitting, by the UAV, images or sensor data collected by scanning the environment and the vehicles surrounding the UAV attached to the one or more non-autonomous vehicles;
receiving, by the UAV, a driving decision from one or more of the autonomous vehicles; and
projecting, by the UAV, the driving decision of the one or more autonomous vehicles onto a windshield or display device of the one or more non-autonomous vehicles attached to the UAV.

2. The computer-implemented method of claim 1, wherein scanning the environment and the vehicles surrounding the UAV is performed using a scanning device selected from the group consisting of an infrared camera, thermal camera, light detection and ranging (LiDAR) and combinations thereof.

3. The computer-implemented method of claim 1, wherein the display device is a heads-up display visible on the windshield of the non-autonomous vehicle or an augmented reality device.

4. The computer-implemented method of claim 1, wherein deploying the UAV to the environment occurs upon one or more of the autonomous vehicles having difficulty driving within the environment due to environmental conditions or presence of the non-autonomous vehicles, and upon alleviation of the difficulty driving, the computer-implemented method further comprises:
detaching the UAV from the one or more non-autonomous vehicles; and
flying the UAV away from the environment comprising the autonomous vehicles and the non-autonomous vehicles driving on the roadway.

5. The computer-implemented method of claim 1, wherein upon a changing of environmental conditions of the roadway or composition of the non-autonomous vehicles present within the environment, the computer-implemented further comprises:
detaching the UAV from the one or more non-autonomous vehicles the UAV is currently attached to;
flying the UAV toward a different non-autonomous within the environment of the roadway;
re-attaching the UAV to a different non-autonomous vehicle within the environment of the roadway; and
scanning, by the UAV, the environment and the vehicles surrounding the UAV attached to the different non-autonomous vehicle.

6. The computer-implemented method of claim 1, further comprising:
receiving, by a processor, data collected by one or more of the autonomous vehicles describing environmental conditions of the roadway and one or more vehicles within the environment; and
identifying, by the processor, which of the one or more vehicles within the environment are the non-autonomous vehicles.

7. The computer-implemented method of claim 6, further comprising:
receiving, a request from one or more of the autonomous vehicles requesting deployment of UAVs to assist with collaboration between the autonomous vehicles and non-autonomous vehicles within the environment; and
based on the data collected by one or more of the autonomous vehicles and the identified non-autonomous vehicles, assigning, by the processor, each UAV being deployed, to a non-autonomous vehicle within the environment.

8. A computer system comprising:
a processor; and
a computer-readable storage media coupled to the processor, wherein the computer-readable storage media contains program instructions executing, via the processor, a computer-implemented method comprising:
deploying an unmanned aerial vehicle (UAV) to an environment comprising the autonomous vehicles and the non-autonomous vehicles driving on a roadway;
attaching the UAV to one or more of the non-autonomous vehicles;
pairing the UAV with one or more of the autonomous vehicles within the environment;
scanning, by the UAV, the environment and vehicles surrounding the UAV attached to one or more non-autonomous vehicles;
transmitting, by the UAV, images or sensor data collected by scanning the environment and the vehicles surrounding the UAV attached to the one or more non-autonomous vehicles;
receiving, by the UAV, a driving decision from one or more of the autonomous vehicles; and
projecting, by the UAV, the driving decision of the one or more autonomous vehicles onto a windshield or display device of the one or more non-autonomous vehicles attached to the UAV.

9. The computer system of claim 8, wherein scanning the environment and the vehicles surrounding the UAV is performed using a scanning device selected from the group consisting of an infrared camera, thermal camera, light detection and ranging (LiDAR) and combinations thereof.

10. The computer system of claim 8, wherein the display device is a heads-up display visible on the windshield of the non-autonomous vehicle or an augmented reality device.

11. The computer system of claim 8, wherein deploying the UAV to the environment occurs upon one or more of the autonomous vehicles having difficulty driving within the environment due to environmental conditions or presence of the non-autonomous vehicles, and upon alleviation of the difficulty driving:
detaching the UAV from the one or more non-autonomous vehicles; and
flying the UAV away from the environment comprising the autonomous vehicles and the non-autonomous vehicles driving on the roadway.

12. The computer system of claim 8, wherein upon a changing of environmental conditions of the roadway or composition of the non-autonomous vehicles present within the environment:
detaching the UAV from the one or more non-autonomous vehicles the UAV is currently attached to;
flying the UAV toward a different non-autonomous within the environment of the roadway;
re-attaching the UAV to a different non-autonomous vehicle within the environment of the roadway; and
scanning, by the UAV, the environment and the vehicles surrounding the UAV attached to the different non-autonomous vehicle.

13. The computer system of claim 8, further comprising:
receiving, by a processor, data collected by one or more of the autonomous vehicles describing environmental conditions of the roadway and one or more vehicles within the environment; and
identifying, by the processor, which of the one or more vehicles within the environment are the non-autonomous vehicles.

14. The computer system of claim 13, further comprising:
receiving, a request from one or more of the autonomous vehicles requesting deployment of UAVs to assist with collaboration between the autonomous vehicles and non-autonomous vehicles within the environment; and
based on the data collected by one or more of the autonomous vehicles and the identified non-autonomous vehicles, assigning, by the processor, each UAV being deployed, to a non-autonomous vehicle within the environment.

15. A computer program product comprising:
one or more computer readable storage media having computer-readable program instructions stored on the one or more computer readable storage media, said program instructions executes a computer-implemented method comprising:
deploying an unmanned aerial vehicle (UAV) to an environment comprising the autonomous vehicles and the non-autonomous vehicles driving on a roadway;
attaching the UAV to one or more of the non-autonomous vehicles;
pairing the UAV with one or more of the autonomous vehicles within the environment;
scanning, by the UAV, the environment and vehicles surrounding the UAV attached to one or more non-autonomous vehicles;
transmitting, by the UAV, images or sensor data collected by scanning the environment and the vehicles surrounding the UAV attached to the one or more non-autonomous vehicles;
receiving, by the UAV, a driving decision from one or more of the autonomous vehicles; and
projecting, by the UAV, the driving decision of the one or more autonomous vehicles onto a windshield or display device of the one or more non-autonomous vehicles attached to the UAV.

16. The computer program product of claim 15, wherein scanning the environment and the vehicles surrounding the UAV is performed using a scanning device selected from the group consisting of an infrared camera, thermal camera, light detection and ranging (LiDAR) and combinations thereof.

17. The computer program product of claim 15, wherein the display device is a heads-up display visible on the windshield of the non-autonomous vehicle or an augmented reality device.

18. The computer program product of claim 15, wherein deploying the UAV to the environment occurs upon one or more of the autonomous vehicles having difficulty driving within the environment due to environmental conditions or presence of the non-autonomous vehicles, and upon alleviation of the difficulty driving:
detaching the UAV from the one or more non-autonomous vehicles; and
flying the UAV away from the environment comprising the autonomous vehicles and the non-autonomous vehicles driving on the roadway.

19. The computer program product of claim 15, wherein upon a changing of environmental conditions of the roadway or composition of the non-autonomous vehicles present within the environment:
detaching the UAV from the one or more non-autonomous vehicles the UAV is currently attached to;
flying the UAV toward a different non-autonomous within the environment of the roadway;
re-attaching the UAV to a different non-autonomous vehicle within the environment of the roadway; and
scanning, by the UAV, the environment and the vehicles surrounding the UAV attached to the different non-autonomous vehicle.

20. The computer program product of claim 15 further comprising:
receiving, by a processor, data collected by one or more of the autonomous vehicles describing environmental conditions of the roadway and one or more vehicles within the environment;
identifying, by the processor, which of the one or more vehicles within the environment are the non-autonomous vehicles;
receiving, a request from one or more of the autonomous vehicles requesting deployment of UAVs to assist with collaboration between the autonomous vehicles and non-autonomous vehicles within the environment; and
based on the data collected by one or more of the autonomous vehicles and the identified non-autonomous vehicles, assigning, by the processor, each UAV being deployed, to a non-autonomous vehicle within the environment.
